(19) United States
(12) Patent Application Publication
(10) Pub. No.: US 2008/0130626 A1
(43) Pub. Date: Jun. 5, 2008

(54) Channel estimation

(76) Inventors: Mika Ventola, Oulu (FI); Kari Majonen, Haukipudas (FI); Kaj Jansen, Salo (FI)

Correspondence Address: SQUIRE, SANDERS & DEMPSEY L.L.P., 8000 TOWERS CRESCENT, 14TH FLOOR, TYSONS CORNER, VA, 22182-2700, US

(21) Appl. No.: 11/984,618

(22) Filed: Nov. 20, 2007

(30) Foreign Application Priority Data
Nov. 28, 2006 (FI) 20065755

(51) Int. Cl. H04J 3/06

(52) U.S. Cl. 370/350

(57) ABSTRACT

A method and an apparatus for channel estimation are provided. The apparatus comprises: a synchronization unit configured to time-synchronize with a received signal on the basis of one or more synchronization patterns of the received signal; a searcher configured to search for pilot sequences of the received signal; an estimator configured to perform channel estimation on the basis of the pilot sequences and one or more synchronization patterns, and a decoder configured to decode cell information from the received signal.

### FIELD

The invention relates to channel estimation, especially in wireless communication systems.

### BACKGROUND

In telecommunication systems, the transmission channel often causes interference to data transmission. Interference occurs in all systems, but in particular in wireless telecommunication systems, the radio path attenuates and distorts the transmitted signal in a variety of ways. On the radio path, interference is typically caused by multipath propagation, various fades and reflections and also another signals transmitted on the same radio path.

Especially for wireless communication systems, various methods have been designed to mitigate the effects of the channel. One key element in the mitigation is channel estimation. In order to cancel the effect of the channel, the channel must first be estimated.

Typically, channel estimation is realized using pilot symbols. A transmitter includes predetermined pilot symbols in the transmission. When the pilot symbols are received in a receiver, the received symbols are multiplied with the complex conjugate of the transmitted pilot symbols, and coefficients of the channel can be detected.

All communication systems suffer from interference and noise. A basic way to mitigate interference and noise is to use averaging. This also applies to pilot symbol transmission. A known method is to receive several pilot symbols and produce corresponding channel estimates by averaging the estimate values obtained from single pilot symbols. Assuming that the channel is fairly constant over the averaging period, the quality of the channel estimates can be improved by using, for example, a simple moving average filter. The quality of the channel estimate is directly related to the number of symbols (samples) used in averaging. A drawback in the averaging method is latency that is caused by receiving several consecutive pilot symbols before the averaged estimate can be produced. On the other hand, when the receiver is moving fast, the assumption about the channel being constant is no longer valid, and the consecutive channel coefficients may vary significantly, which restricts the maximum length of the averaging period.

The problems explained above are difficult to solve especially in cases were good quality of channel estimates are required but long averaging periods cannot be used. This is the case, for example, in the detection of control channels of wireless communication systems where latency requirements are strict. For example, data of a control channel often has to be detected quickly in a mobile terminal in order to allow fast feedback to a base station. Another example is when a receiver wakes up from an idle mode. In such a case, the detection of a system information field of a data frame should be performed quickly. In future wireless systems, the latency and round-trip time requirements are even stricter than in the present systems.

### BRIEF DESCRIPTION OF THE INVENTION

An object of the invention is to provide an improved solution for estimating a channel. According to an aspect of the invention, there is provided a method comprising: receiving at a receiver a signal comprising one or more synchronization patterns and pilot sequences; performing channel estimation on the basis of the pilot sequences and one or more synchronization patterns.

According to another aspect of the invention, there is provided a method comprising: time-synchronizing with a received signal on the basis of one or more synchronization patterns of the received signal; searching for pilot sequences of the received signal; performing channel estimation on the basis of the pilot sequences and one or more synchronization patterns; and decoding cell information from the received signal.

According to another aspect of the invention, there is provided a receiver configured to receive a signal comprising one or more synchronization patterns and pilot sequences and comprising an estimator configured to perform channel estimation on the basis of the pilot sequences and one or more synchronization patterns.

According to another aspect of the invention, there is provided an apparatus comprising: a synchronization unit configured to time-synchronize with a received signal on the basis of one or more synchronization patterns of the received signal; a searcher configured to search for pilot sequences of the received signal; an estimator configured to perform channel estimation on the basis of the pilot sequences and one or more synchronization patterns, and a decoder configured to decode cell information from the received signal.

According to another aspect of the invention, there is provided an apparatus comprising: means for time-synchronizing with a received signal on the basis of one or more synchronization patterns of the received signal; means for searching for pilot sequences of the received signal; means for performing channel estimation on the basis of the pilot sequences and one or more synchronization patterns, and means for decoding cell information from the received signal.

According to yet another aspect of the invention, there is provided an integrated circuit comprising: a synchronization unit configured to time-synchronize with a received signal on the basis of one or more synchronization patterns of the received signal; a searcher configured to search for pilot sequences of the received signal; and an estimator configured to perform channel estimation on the basis of the pilot sequences and one or more synchronization patterns.

### LIST OF DRAWINGS

In the following, the invention will be described in greater detail with reference to the embodiments and the accompanying drawings, in which

FIG. 1 shows an example of a data transmission system to which embodiments of the invention may be applied;

FIGS. 2A and 2B illustrate an example of the structure of a frequency channel in an Orthogonal Division Multiple Access system;

FIGS. 3A, 3B and 3C are flowcharts illustrating embodiments of the invention; and

FIG. 4 illustrates an example of a receiver to which embodiments of the invention may be applied.

### DESCRIPTION OF EMBODIMENTS

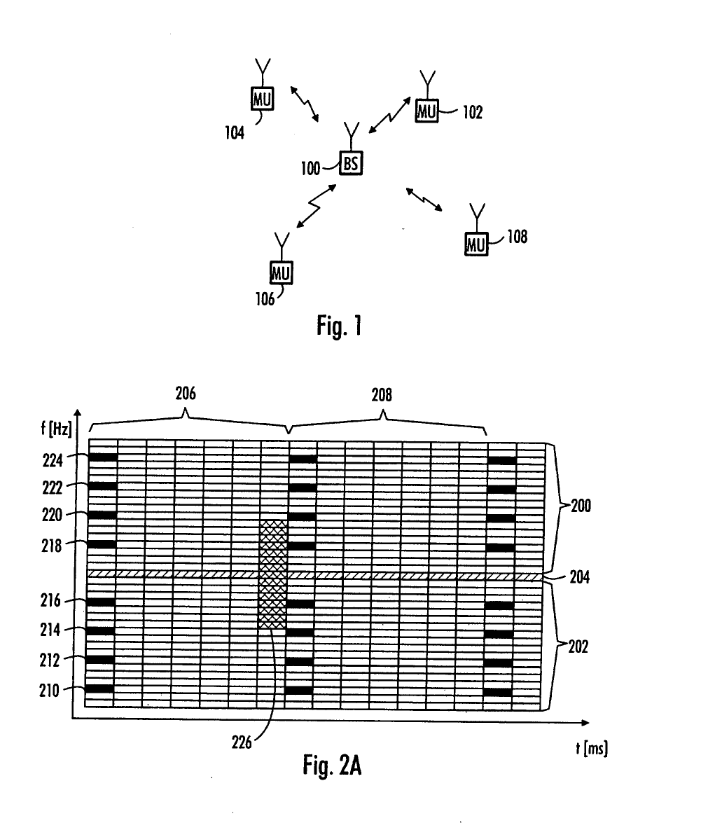

With reference to FIG. 1, examine an example of a data transmission system to which embodiments of the invention may be applied. The present invention is applicable to various communication systems where different multiple access methods may be used. A typical example of a system to which the invention may be applied is the evolution of the third-generation system utilizing EUTRA (Enhanced Universal Terrestrial Radio Access) as a radio access network. EUTRA is currently being developed. EUTRA is also called 3.9G or UTRAN LTE (Universal Terrestrial Radio Access Network Long-Term Evolution). However, the embodiments of the invention are not limited to EUTRA.

FIG. 1 shows a base station 100 and a group of mobile units 102, 104, 106 and 108. In this example, the mobile units 102 to 108 communicate in the uplink direction with the base station 100 by using an SC-FDMA (Single Carrier Frequency Division Multiple Access) scheme. In the downlink direction, OFDMA (Orthogonal Frequency Division Multiple Access) is used. However, embodiments of the invention are not limited to any particular multiple access method. The mobile units in FIG. 1 may be mobile, stationary or fixed user equipment, as one skilled in the art is aware.

An embodiment of the invention is described using a cell search procedure in a system utilizing OFDMA in the downlink direction as an example. However, embodiments of the invention are not limited to cell search situations, as one skilled in the art is aware.

When a mobile unit is switched on, the unit must establish a connection to a network. Typically, the connection establishment begins with a synchronization procedure. In many wireless communication systems, base stations of the networks transmit a synchronization channel which is utilized by the mobile units in the synchronization procedure.

The synchronization channel is a signaling channel comprising a known bit or symbol synchronization pattern. Typically, all base stations of a network transmit the same synchronization pattern.

A mobile unit, when switched on, starts to scan a given frequency for a synchronization channel. The scanned frequency may be the frequency that the mobile unit used the last time it was on or it may be selected from a set of frequencies stored in the memory of the mobile unit. The scan may be performed by correlating the given frequency with the known synchronization channel bit or symbol pattern. When a large enough correlation peak is detected, the mobile unit determines that the synchronization channel of a base station has been found. The mobile unit obtains coarse symbol/frame timing from the synchronization channel and performs coarse frequency error correction. If a large enough correlation peak cannot be found on a given frequency, the mobile unit determines that there are no nearby base stations using the given frequency and starts scanning another frequency.

When the mobile unit has obtained synchronization, it searches for pilot sequences from the signal transmitted by the base station on the given frequency. Each base station includes pilot sequences in the trans-mission on each channel for channel estimation purposes. When the pilot sequences are found and received by the mobile unit, the received sequences are multiplied with the complex conjugate of the transmitted pilot sequences, and coefficients of the channel can be detected.

In an embodiment of the invention, the mobile unit performs channel estimation on the basis of the pilot sequences and one or more synchronization patterns. By using both pilot sequences and one or more synchronization patterns, the number of samples in the channel estimation may be increased without increasing latency.

For example, when a mobile unit wakes up from idle mode or deep sleep the problem with latency may occur in prior art solutions as the mobile unit should establish a connection with a base station quickly but receiving a reliable number of pilot sequences for averaging may take a long time. In an embodiment of the invention, a first pilot is received but the quality is not necessarily good enough due to the low number of samples. Next, a synchronization channel is received and channel estimate is determined using the synchronization pattern. The channel estimate from the synchronization channel may be used to improve the channel estimate obtained from the pilot without having to wait for the next pilot symbol transmission. In this way, a reliable channel estimate may be obtained earlier than in prior art solutions by combining channel estimates obtained using the pilot sequences and one or more synchronization patterns with each other.

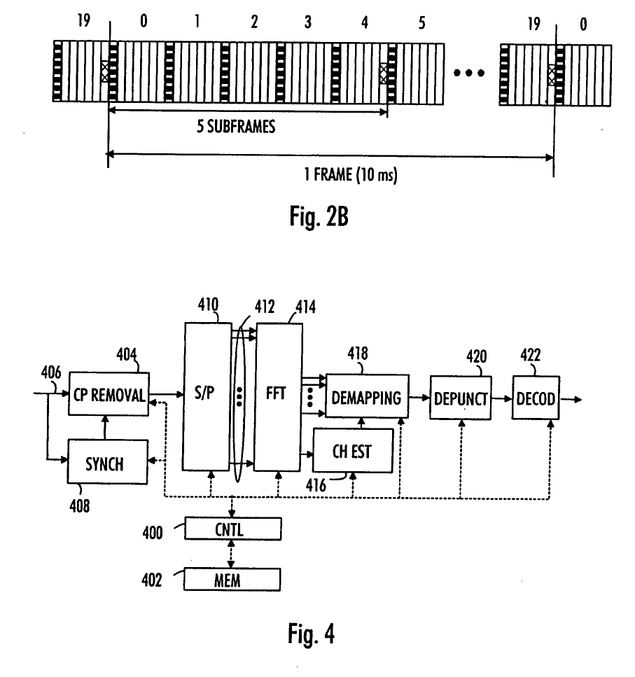

FIGS. 2A and 2B illustrate an example of the structure of a frequency channel in an OFDMA system. Time is on the horizontal axis and frequency is on the vertical axis. In FIG. 2A, the subcarriers of the frequency channel are divided above 200 and below 202 of the center frequency 204. FIG. 2A shows two successive subframes 206, 208, each comprising seven time slots. The total bandwidth of the channel may be 1.25, 2.5, 5.0, 10.0, 15.0 or 20.0 MHz, for example. In an OFDMA system, channels of different bandwidths may be in use, depending on the required transmission capacity. It should be noted that the numerical values (the number of subcarriers, subframes, bandwidth and time slots, for example) are merely used as an illustrative example. Embodiments of the invention are not limited to any particular channel structure.

In each subframe, some of the time slots are reserved for the transmission of a pilot sequence. In the example of FIG. 2A, eight time slots 210 to 224 are reserved for the transmission of a pilot sequence, four time slots above the center frequency and four time slots below the center frequency. Thus, pilot sequences may be sent using a subset of available subcarriers.

The first subframe 206 of FIG. 2A comprises a synchronization pattern 226. The synchronization pattern is multiplexed around the center frequency and in the example of FIG. 2A the bandwidth used in the transmission of the pattern is 1.25 MHz regardless of the total bandwidth of the channel. Thus, a mobile unit can acquire initial synchronization from the centermost 1.25-MHz band of the channel regardless of the total bandwidth of the channel. The total bandwidth of the channel does not have to be known when initial synchronization is performed.

FIG. 2B illustrates an example of the frame structure of a frequency channel in an OFDMA system. The signal on the channel is divided into frames having the length of 10 ms in the example of FIG. 2B. Each frame comprises 20 subframes. A synchronization channel is realized by transmitting a synchronization pattern in every fifth subframe. Thus, the synchronization pattern is repeated four times within each 10-ms frame. As a pilot sequence is transmitted using part of the first time slots of each subframe, the number of pilot sequences per one 10-ms frame is 20.

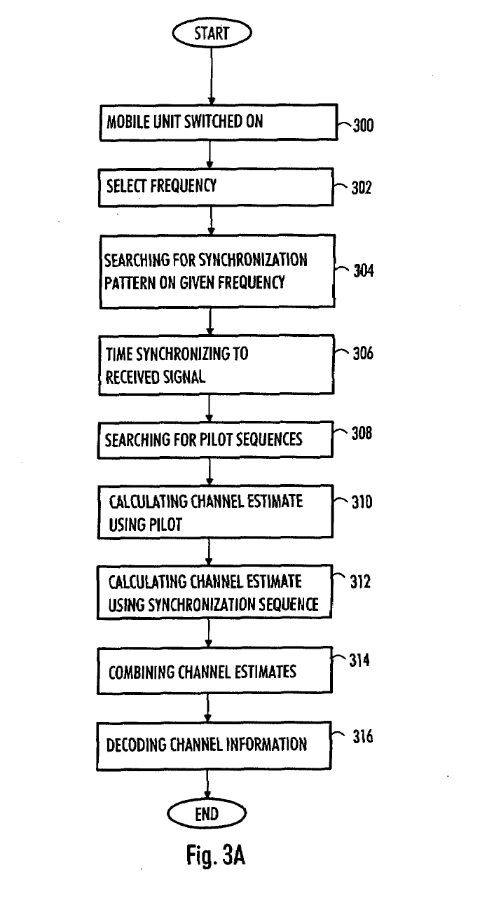

The flowchart of FIG. 3A illustrates an example where an embodiment of the invention is applied.

In step 300, a mobile unit is switched on.

In step 302, the mobile unit selects a frequency on which it will start searching for a base station. The frequency may be the frequency that the mobile unit used the last time it was on or it may be selected from a set of frequencies stored in the memory of the mobile unit.

In step 304, the mobile unit starts searching for synchronization patterns on the given frequency. In the example of FIGS. 2A and 2B, the mobile unit searches the pattern transmitted on a 1.25-Mhz bandwidth around the center frequency of a channel. The search may be realized by correlating the above-mentioned frequency band with a known synchronization sequence pattern.

In step 306, the mobile unit detects one or more synchronization patterns. The mobile unit determines that a base station is transmitting a signal on the given frequency and time-synchronizes itself to the received signal.

In step 308, the mobile starts searching for pilot sequences from the received signal. The search may be realized by correlating the received signal with known pilot sequence patterns. The mobile unit knows the pilot sequences allowed in the system. These patterns are used in the correlation calculation until a correlation peak is detected. The mobile unit may be configured to search for pilot sequences of the received signal from all subcarriers or from a subset of available subcarriers.

In step 310, the mobile unit detects pilot sequences, and channel estimation on the basis of the pilot sequences may be performed. In general, the signal r received from a base station may be described with a formula

r=ph+n,

where p is the known pilot sequence, h is a channel impulse response and n represents noise. If the received signal is multiplied with the complex conjugate p* of the known pilot sequence, an estimate ĥ of the channel impulse response is obtained:

ĥ=h+np*.

The mobile unit is configured to calculate a channel estimate ĥₚ by using pilot sequences.

In step 312, the mobile unit is configured to calculate a channel estimate ĥₛ by utilizing one or more synchronization patterns in the calculation. In an embodiment, the received synchronization patterns may be described with a formula

r=sh+n,

where s is the known synchronization pattern, h is a channel impulse response and n represents noise. If the received signal is multiplied with the complex conjugate s* of the known synchronization pattern, an estimate ĥₛ of the channel impulse response is obtained:

ĥₛ=h+ns.

In step 314, the mobile unit is configured to combine the calculated channel impulse responses ĥₚ and ĥₛ. The combination may be calculated using a following formula:

$$\overline{h} = \frac{1}{2} ( {\hat{h}}_{p} + {\hat{h}}_{s} ) .$$

The results may be combined using some other formulas as well, as one skilled in the art is aware. For example, either ĥₚ or ĥₛ could be emphasized in the combining depending on the estimated reliability of the results.

In step 316, the mobile unit is configured to decode more cell related information from the transmission of the base station. The mobile unit may decode a broadcast control channel, for example.

The flowchart of FIG. 3B illustrates an example of an embodiment.

In step 320, a mobile unit is configured to calculate channel estimates ĥₚ on the basis of pilot sequences for those subcarriers on which the pilot sequences are transmitted.

In step 322, the mobile unit is further configured to interpolate channel estimates for all subcarriers on the basis of the calculated channel estimates.

In step 324, the mobile unit is configured to calculate a channel estimate ĥₛ by utilizing one or more synchronization patterns in the calculation.

In step 326, the interpolated estimates are combined with the channel estimate ĥₛ obtained using synchronization patterns.

The flowchart of FIG. 3C illustrates another example of an embodiment.

In step 330, a mobile unit is configured to calculate channel estimates on the basis of pilot sequences for those subcarriers on which the pilot sequences are transmitted.

In step 332, the mobile unit is configured to calculate a channel estimate ĥₛ by utilizing one or more synchronization patterns in the calculation.

In step 334, the estimates calculated using pilot sequences are combined with the channel estimates obtained using synchronization patterns. Thus, combined channel estimates for the subcarriers on which the pilot sequences are transmitted are obtained.

In step 336, the mobile unit is further configured to interpolate channel estimates for all subcarriers on the basis of the calculated channel estimates.

The connection between the mobile unit and the base station may be set up in a known manner after the cell-related information has been decoded by the mobile unit.

Above, an embodiment of the invention is described in connection with connection establishment. However, embodiments of the invention are not limited to connection establishment procedures. For example, a mobile unit having a connection with a base station may search for transmissions of neighboring base stations in a similar manner. The described channel estimation procedures may then be applied as well.

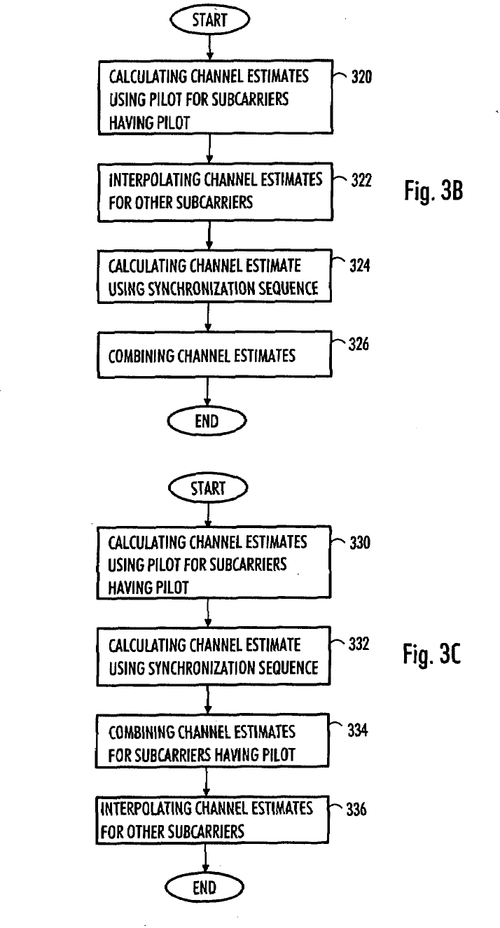

With reference to FIG. 4, examine an example of a receiver to which embodiments of the invention may be applied. The receiver comprises a controller 400 with a memory 402, the controller being typically implemented with a microprocessor, a signal processor or separate components and associated software. The memory 402 may store software and other data for the controller 400. The controller, the memory and different parts of the receiver may be implemented with one or more integrated circuits such as ASICs (Application Specific Integrated Circuits).

The operation of the receiver is first described when it is receiving a signal from a transmitter. Thus, connection has already been established with the transmitter. A radio frequency part of the receiver (not shown) forwards the received signal 406 to a processing unit 404. The processing unit is configured to remove a cyclic prefix, if any, from the signal. The signal is further applied to a first transformer 410 which is configured to convert the signal into a parallel form. The parallel-form signal 412 is applied to a second trans-former 414 which performs FFT (Fast Fourier Transform) to the signal. The transformed signal is taken to a demapper 418 configured to demodulate the signal into a serial form. The signal is then taken to a processing unit 420 configured to perform depuncturing and deinterleaving. The deinterleaved signal is taken to a decoder unit 422. The decoder unit may be configured to decode cell information from the received signal. The receiver further comprises a channel estimator 416 configured to calculate a channel estimate on the basis of pilot symbols.

The received signal 406 is also taken to a processing unit 408 which is configured to synchronize with the received signal by correlating the signal with the known synchronization pattern. In connection establishment, the synchronization must be performed first as described above. The synchronization processing unit 408 (as all units of the receiver) is controlled by the controller 400.

In an embodiment, the controller 400 controls the synchronization processing unit 408 and the channel estimator to calculate channel estimates together. The synchronization processing unit 408 calculates the channel estimates on the basis of synchronization patterns. The channel estimator 416 calculates channel estimates on the basis of pilot symbols. The controller may be configured to combine the calculated channel estimates. Thus, a reliable channel estimate may be calculated quickly with small latency.

The controller 400 controls the operation of the receiver. The controller may be realized with a signal-processing or general processor and associated software which may be stored in the memory 1122. The controller may be realized with discrete logic circuits or an ASIC (Application Specific Integrated Circuit).

Other parts of the receiver shown in FIG. 4 may also be realized using signal-processing units. The units may be realized using one or more integrated circuits.

The controller 400 and said processing units and other units of the receiver may be configured to perform at least some of the steps described in connection with the flowchart of FIG. 3 and in connection with FIGS. 2A, 2B and 4. Embodiments may be implemented as a computer program comprising instructions for executing a computer process, the process comprising: time-synchronizing with a received signal on the basis of one or more synchronization patterns of the received signal; searching for pilot sequences of the received signal; performing channel estimation on the basis of pilot sequences and one or more synchronization patterns, and decoding cell information from the received signal.

The computer program may be stored on a computer program distribution medium readable by a computer or a processor. The computer program medium may be, but is not limited to, an electric, magnetic, optical, infrared or semiconductor system, device or transmission medium. The computer program medium may include at least one of the following media: a computer readable medium, a program storage medium, a record medium, a computer readable memory, a random access memory, an erasable programmable read-only memory, a computer readable software distribution package, a computer readable signal, a computer readable telecommunications signal, computer readable printed matter, and a computer readable compressed software package.

Even though the invention has been described above with reference to an example according to the accompanying drawings, it is clear that the invention is not restricted thereto but can be modified in several ways within the scope of the appended claims.

1. A method comprising:
receiving, at a receiver, a signal comprising one or more synchronization patterns and pilot sequences;
performing channel estimation based on the pilot sequences and the one or more synchronization patterns.

2. The method of claim 1, further comprising:
receiving a frame-format signal comprising several subcarriers, each frame comprising a given number of subframes, the signal having pilot sequences in at least one time slot of each sub frame on at least one subcarrier and a given number of synchronization patterns within each frame.

3. The method of claim 2, further comprising:
searching for pilot sequences of the received signal from a subset of available subcarriers.

4. The method of claim 2, further comprising:
utilizing the pilot sequences received on a subset of available sub-carriers in the channel estimation.

5. The method of claim 4, further comprising:
interpolating channel estimates for all subcarriers based on the channel estimates determined from the pilot sequences.

6. The method of claim 5, further comprising:
utilizing the one or more synchronization patterns when determining a channel estimate, and combining the obtained estimate with the channel estimates obtained using interpolation.

7. The method of claim 4, further comprising:
utilizing the one or more synchronization patterns when determining a channel estimate;
combining the obtained estimate with the estimate obtained using pilot sequences; and
interpolating channel estimates for all subcarriers based on the combined channel estimates.

8. A method comprising:
time-synchronizing with a received signal based on one or more synchronization patterns of the received signal;
searching for pilot sequences of the received signal;
performing channel estimation based on the pilot sequences and the one or more synchronization patterns; and
decoding cell information from the received signal.

9. The method of claim 8, further comprising:
combining the channel estimation results obtained using the pilot sequences and the one or more synchronization patterns with each other.

10. A receiver comprising:
an estimator configured to perform channel estimation based on pilot sequences and one or more synchronization patterns,
wherein the receiver is configured to receive a signal comprising the one or more synchronization patterns and the pilot sequences.

11. The receiver of claim 10, further configured to:
receive a frame-format signal comprising several subcarriers, each frame comprising a given number of subframes, the signal having pilot sequences in at least one time slot of each subframe on at least one subcarrier and a given number of synchronization patterns within each frame.

12. The receiver of claim 11, further configured to:
search for the pilot sequences of the received signal from a subset of available subcarriers.

13. The receiver of claim 11, further configured to:
utilize the pilot sequences received on a subset of available subcarriers in channel estimation.

14. The receiver of claim 10, further configured to:
combine the channel estimation results obtained using the pilot sequences and the one or more synchronization patterns with each other.

15. The receiver of claim 13, further configured to:
interpolate channel estimates for all subcarriers based on the channel estimates determined from the pilot sequences.

16. The receiver of claim 15, further configured to:
utilize the one or more synchronization patterns when determining a channel estimate, and
combine the obtained estimate with the channel estimates obtained using interpolation.

17. The receiver of claim 13 further configured to:
utilize the one or more synchronization patterns when determining a channel estimate;
combine the obtained estimate with the estimate obtained using the pilot sequences; and
interpolate channel estimates for all subcarriers based on the combined channel estimates.

18. An apparatus comprising:
a synchronization unit configured to time-synchronize with a received signal based on one or more synchronization patterns of the received signal and to perform channel estimation based on one or more synchronization patterns;
a searcher configured to search for pilot sequences of the received signal;
an estimator configured to perform channel estimation based on the pilot sequences and the one or more synchronization patterns; and
a decoder configured to decode cell information from the received signal.

19. The apparatus of claim 18, comprising a controller configured to combine the channel estimation results obtained using the pilot sequences and the one or more synchronization patterns with each other.

20. An integrated circuit comprising:
a synchronization unit configured to time-synchronize with a received signal based on one or more synchronization patterns of the received signal;
a searcher configured to search for pilot sequences of the received signal; and
an estimator configured to perform channel estimation based on the pilot sequences and the one or more synchronization patterns.

21. The integrated circuit of claim 20, further configured to combine the channel estimation results obtained using the pilot sequences and the one or more synchronization patterns with each other.

22. A computer program distribution medium readable by a computer and encoding a computer program of instructions for executing a computer process comprising program instructions for causing a processor to perform a process, comprising:
receiving, at a receiver, a signal comprising one or more synchronization patterns and pilot sequences;
performing channel estimation based on the pilot sequences and the one or more synchronization patterns.

23. The computer program distribution medium of claim 22, the process further comprising: receiving a frame-format signal comprising several subcarriers, each frame comprising a given number of subframes, the signal having pilot sequences in at least one time slot of each sub frame on at least one subcarrier and a given number of synchronization patterns within each frame.

24. The computer program distribution medium of claim 23, the process further comprising: searching for pilot sequences of the received signal from a subset of available subcarriers.

25. The computer program distribution medium of claim 23, the process further comprising: utilizing the pilot sequences received on a subset of available subcarriers in the channel estimation.
